(19) United States
(12) Patent Application Publication
(10) Pub. No.: US 2018/0095431 A1
(43) Pub. Date: Apr. 5, 2018

(54) DUAL INPUT VOLTAGE POWER SUPPLY

(71) Applicant: ETASIS ELECTRONICS CORPORATION, TAIPEI CITY (TW)

(72) Inventors: I-CHIA LEE, TAIPEI CITY (TW); CHE-YU LIN, TAIPEI CITY (TW)

(21) Appl. No.: 15/718,046

(22) Filed: Sep. 28, 2017

(30) Foreign Application Priority Data
Oct. 5, 2016 (TW) 105215119

(51) Int. Cl. G05B 11/01; H02M 7/04; H02M 3/04

(52) U.S. Cl. CPC G05B 11/01; H02M 1/4208; H02M 3/04; H02M 7/04

(57) ABSTRACT

A dual input voltage power supply includes a first AC power input end, a second AC power input end, an AC selector relay, a power factor correction circuit, a support circuit, a DC/DC converter, a voltage adjusting module and a plurality of output power lines. The dual input voltage power supply has a plurality of DC power output ends to provide different DC power outputs. One of the first AC power input end and the second AC power input end is a master power supply, and the other is a slave power supply. When the master power supply works abnormally, the slave power supply provides the power required by the dual input voltage power supply.

### BACKGROUND OF THE INVENTION

### 1. Field of the Invention

The present disclosure relates to a dual input voltage power supply; in particular, to a dual input AC (Alternating Current; AC) voltage power supply

### 2. Description of Related Art

Currently, some power supplies may be able to provide two output powers to electronic devices, and one output power is the master output power and the other output power is the slave output power. However, these power supplies do not have two power input ends to have the power from one power input end as the master input power and have the power from the other power input end as the slave input power.

### SUMMARY OF THE INVENTION

The present disclosure provides a dual input voltage power supply. The dual input voltage power supply includes a first AC power input end, a second AC power input end, an AC selector relay, a power factor correction circuit, a support circuit, a DC/DC converter and a voltage adjusting module. The first AC power input end receives a first commercial power, and the second AC power input end receives a second commercial power. The AC selector relay is connected to the first AC power input end and the second AC power input end for choosing to receive the first commercial power from the first AC power input end or the second commercial power from the second AC power input end. The power factor correction circuit is connected to the AC selector relay for power factor correction. The support circuit is connected to the power factor correction circuit to provide a support power. The DC/DC converter is connected to the power factor correction circuit. The voltage adjusting module is connected to the DC/DC converter, and has a plurality of DC (Direct Current; DC) power output ends. One of the first AC power input end and the second AC power input end is a master power supply, and the other is a slave power supply.

In one of embodiment of the dual input voltage power supply provided by the present disclosure, the voltage adjusting module includes a first voltage adjusting module, a second voltage adjusting module and a plurality of third voltage adjusting modules. The first voltage adjusting module is a 12V voltage adjusting module, the second voltage adjusting module is a 5V voltage adjusting module and the third voltage adjusting module is a 3V voltage adjusting module.

In one of embodiment of the dual input voltage power supply provided by the present disclosure, the dual input voltage power supply further includes a controller of the AC selector relay. Two input ends of the controller of the AC selector relay are connected respectively to the first AC power input end and the second AC power input end, and an output end of the controller of the AC selector relay is connected to the AC selector relay.

In one of embodiment of the dual input voltage power supply provided by the present disclosure, the voltage adjusting module has a plurality of output power lines to provide a plurality of DC power outputs.

In one of embodiment of the dual input voltage power supply provided by the present disclosure, when the master power supply works abnormally, the slave power supply provides the power required by the dual input voltage power supply.

The present disclosure provides another dual input voltage power supply. The dual input voltage power supply includes a housing, a first AC power input end, a second AC power input end and a circuit board. The first AC power input end is configured at a front end of the housing to receive a first commercial power. The second AC power input end is configured at the front end of the housing and beside the first AC power input end to receive a second commercial power. The circuit board is configured in the housing, and connected to the first AC power input end and the second AC power input end. The circuit board includes an AC selector relay, a power factor correction circuit, a support circuit, a DC/DC converter and a voltage adjusting module. The AC selector relay is connected to the first AC power input end and the second AC power input end for choosing to receive the first commercial power from the first AC power input end or the second commercial power from the second AC power input end. The power factor correction circuit is connected to the AC selector relay for power factor correction. The support circuit is connected to the power factor correction circuit to provide a support power. The DC/DC converter is connected to the power factor correction circuit. The voltage adjusting module is connected to the DC/DC converter, and has a plurality of DC power output ends. One of the first AC power input end and the second AC power input end is a master power supply, and the other is a slave power supply.

In one of embodiment of the dual input voltage power supply provided by the present disclosure, the voltage adjusting module includes a first voltage adjusting module, a second voltage adjusting module and a plurality of third voltage adjusting modules. The first voltage adjusting module is a 12V voltage adjusting module, the second voltage adjusting module is a 5V voltage adjusting module, and the third voltage adjusting module is a 3V voltage adjusting module.

In one of embodiment of the dual input voltage power supply provided by the present disclosure, the dual input voltage power supply further includes a controller of the AC selector relay. Two input ends of the controller of the AC selector relay are connected respectively to the first AC power input end and the second AC power input end, and an output end of the controller of the AC selector relay is connected to the AC selector relay.

In one of embodiment of the dual input voltage power supply provided by the present disclosure, the voltage adjusting module has a plurality of output power lines to provide a plurality of DC power outputs.

In one of embodiment of the dual input voltage power supply provided by the present disclosure, when the master power supply works abnormally, the slave power supply provides the power required by the dual input voltage power supply.

To sum up, the dual input voltage power supply provided by the present disclosure has a first AC power input end and a second AC power input end, so a first commercial power can be received by the first AC power input end and a second commercial power can be received by the second AC power input end. Thus, when one of the first commercial power and the second commercial power is unavailable, the other can be a substitute. The dual input voltage power supply provided by the present disclosure can be used in DC power supply devices, such as a solar power generation device, a wind power generation device or an uninterruptable power system.

For further understanding of the present disclosure, reference is made to the following detailed description illustrating the embodiments of the present disclosure. The description is only for illustrating the present disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a perspective drawing of a dual input voltage power supply according to one embodiment of the present disclosure;

FIG. 2 shows a top view of the interior of a dual input voltage power supply according to one embodiment of the present disclosure; and

FIG. 3 shows a circuit diagram of a dual input voltage power supply according to one embodiment of the present disclosure.

### DETAILED DESCRIPTION OF EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings. In these drawings, like references indicate similar elements.

It will be understood that, although the terms first, second, third, and the like, may be used herein to describe various elements, these elements should not be limited by these terms. These terms are only to distinguish one element from another element, and the first element discussed below could be termed a second element without departing from the teachings of the instant disclosure. As used herein, the term “and/or” includes any and all combinations of one or more of the associated listed items.

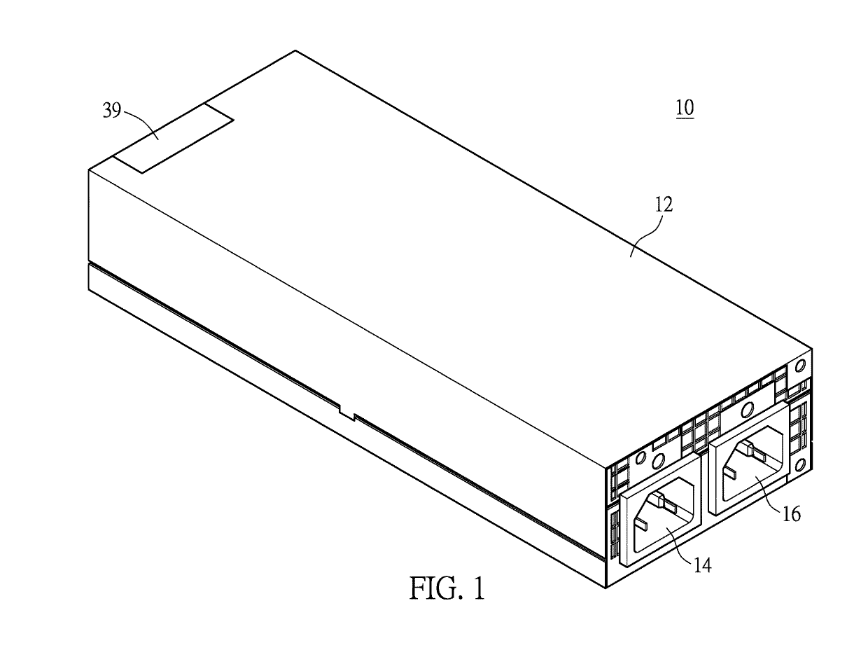

The dual input voltage power supply 10 has two AC power input ends, and thus the dual input voltage power supply 10 can choose one of two commercial powers as its input power and take the other commercial power as a substitute. Referring to FIG. 1, a perspective drawing of a dual input voltage power supply according to one embodiment of the present disclosure is shown. As shown in FIG. 1, the dual input voltage power supply 10 includes a housing 12, a first AC power input end 14 and a second AC power input end 16. The dual input voltage power supply 10 can receive a first commercial power from the first AC power input end 14, or can receive a second commercial power from the second AC power input end 16. The first AC power input end 14 and the second AC power input end 16 are both configured at the front end of the dual input voltage power supply 10, and the second AC power input end 16 is configured beside the first AC power input end 14.

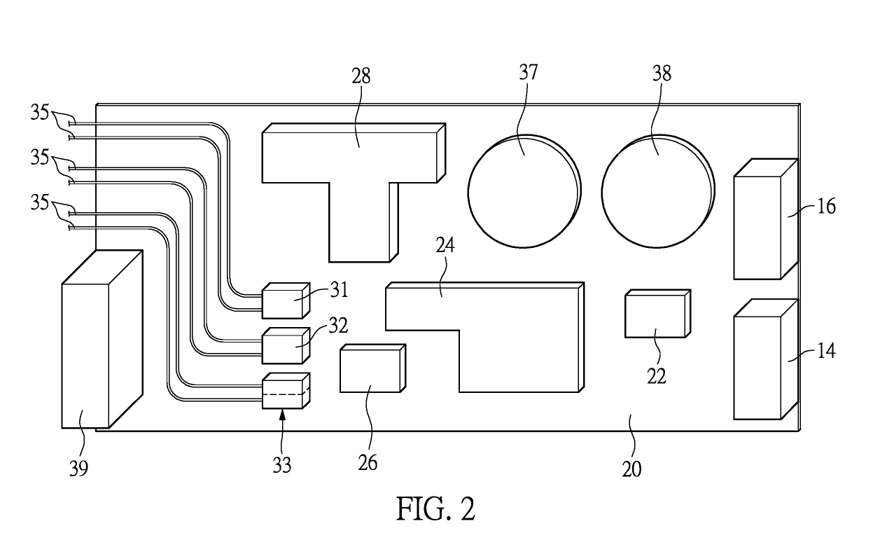

Referring to FIG. 2, a top view of the interior of a dual input voltage power supply according to one embodiment of the present disclosure is shown. FIG. 2 shows the circuit configuration of the dual input voltage power supply 10 inside its housing 12, but FIG. 2 is only for illustrating but not for restricting the circuit configuration of the dual input voltage power supply 10 inside provided by the present disclosure. In other words, the circuit configuration of the dual input voltage power supply 10 provided by the present disclosure can be adjusted depending on actual needs. A circuit board 20 is configured in the housing 12. An AC selector relay 22, a power factor correction circuit 24, a support circuit 26, a DC/DC converter 28 and a voltage adjusting module 30 are configured on the circuit board 20. In addition, a capacitor 37 and an inductor 38 are also configured on the circuit board 20. The voltage adjusting module 30 has a plurality of output power lines 35. The circuit board 20 is connected to the first AC power input end 14 and the second AC power input end 16 such that the first commercial power or the second commercial power can be inputted to the circuit board 20.

The AC selector relay 22 is connected to the first AC power input end 14 and the second AC power input end 16. As shown in FIG. 2, the first AC power input end 14 and the second AC power input end 16 are configured at a side of the circuit board 20. The AC selector relay 22 is configured not at any side of the circuit board 20, but beside the first AC power input end 14 and the second AC power input end 16 for choosing the first commercial power from the first AC power input end or the second commercial power from the second AC power input end to receive.

The power factor correction circuit 24 is connected to the AC selector relay 22 for correcting the power factor of the dual input voltage power supply 10. The power factor correction circuit 24 is configured next to the AC selector relay 22, and they are connected through the wiring embedded in the circuit board 20. The support circuit 26 is configured next to the power factor correction circuit 24, and they are connected through the wiring embedded in the circuit board 20. The support circuit 26 is configured to provide a support power. The DC/DC converter 28 is configured next to the power factor correction circuit 24 through the wiring embedded in the circuit board 20. The DC/DC converter 28 is configured to convert DC voltages for providing a voltage rise or a voltage drop.

The voltage adjusting module 30 is connected to the DC/DC converter 28 through the wiring embedded in the circuit board 20. In this embodiment, the voltage adjusting module 30 includes a first voltage adjusting module 31, a second voltage adjusting module 32 and a third voltage adjusting module 33. For example, the first voltage adjusting module 31 is a voltage adjusting module that outputs 12V voltage, and the second voltage adjusting module 32 is a voltage adjusting module that outputs 5V voltage. In addition, the number of the third voltage adjusting module 33 is three and each of them outputs 3V voltage. The number of the first voltage adjusting module 31, the second voltage adjusting module 32 and the third voltage adjusting module 33 can be freely designed depending on different required output voltages. Each of the first voltage adjusting module 31, the second voltage adjusting module 32 and the third voltage adjusting module 33 is connected to a plurality of output power lines 35, such that the voltage adjusting module 30 can output different DC voltages.

It should be noted that, in this embodiment, the commercial power received by one of the first AC power input end 14 and the second AC power input end 16 is the master power supply, and the commercial power received by the other is the slave power supply. For example, if the commercial power received by the first AC power input end 14 is the master power supply, when the first AC power input end 14 works abnormally or the commercial power received by the first AC power input end 14 is unavailable, the slave power supply (which is the second AC power input end 16) will provide the power required by the dual input voltage power supply 10. The capacitor 37 and the inductor 38 on the circuit board 20 are part of the power factor correction circuit 24, and they are connected through the wiring embedded in the circuit board 20. Moreover, a fan 39 is configured on the circuit board 20 to dissipate the heat generated during the operation of the dual input voltage power supply 10.

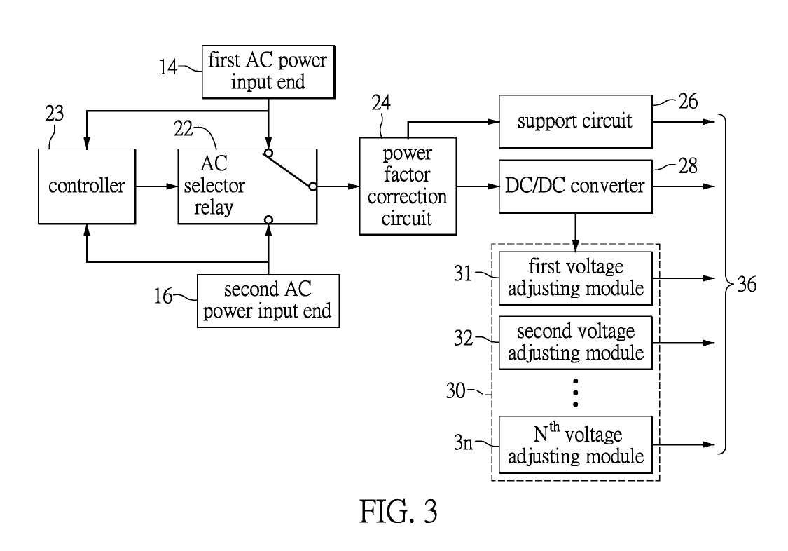

Referring to FIG. 3, a circuit diagram of a dual input voltage power supply according to one embodiment of the present disclosure is shown. As shown in FIG. 2 and FIG. 3, the dual input voltage power supply 10 provided by the present disclosure includes a first AC power input end 14, a second AC power input end 16, an AC selector relay 22, a controller 23 of the AC selector relay 22, a power factor correction circuit 24, a support circuit 26, a DC/DC converter 28 and a voltage adjusting module 30, and the dual input voltage power supply 10 provided by the present disclosure can provide a plurality of DC power outputs 36. The AC selector relay 22 is connected to the first AC power input end 14 and the second AC power input end 16 for choosing to receive the first commercial power from the first AC power input end or the second commercial power from the second AC power input end. One input end of the AC selector relay 22 is connected to one output end of the controller 23 of the AC selector relay 22, such that the controller 23 controls the AC selector relay 22 to choose the first commercial power from the first AC power input end or the second commercial power from the second AC power input end as the input power of the dual input voltage power supply 10. Two input ends of the controller 23 of the AC selector relay 22 are connected respectively to the first AC power input end 14 and the second AC power input end 16. According to the working conditions of the first AC power input end 14 and the second AC power input end 16, the controller 23 chooses the first commercial power from the first AC power input end or the second commercial power from the second AC power input end as the input power of the dual input voltage power supply 10.

As shown in FIG. 3, the power factor correction circuit 24 is connected to the AC selector relay 22 to correct the power factor of the dual input voltage power supply 10. The support circuit 26 is connected to the power factor correction circuit 24 to provide a support power. The DC/DC converter 28 is connected to the power factor correction circuit 24 to convert DC voltages for providing a voltage rise or a voltage drop. The voltage adjusting module 30 is connected to the DC/DC converter 28 to provide a plurality of DC power outputs 36. The support power from the support circuit 26 and the DC voltage from the DC/DC converter 28 can also be provided as the DC power outputs 36. In FIG. 3, the voltage adjusting module includes a first voltage adjusting module 31, a second voltage adjusting module 32, . . . , and a N^{th} voltage adjusting module 3n.

For example, the first voltage adjusting module 31 can be a voltage adjusting module that outputs 12V voltage, the second voltage adjusting module 32 can be a voltage adjusting module that outputs 5V voltage. In addition, each of the other voltage adjusting modules can be a voltage adjusting module that outputs 3V voltage. However, the number of the voltage adjusting module outputting 12V voltage, the number of the voltage adjusting module outputting 5V voltage and the number of the voltage adjusting module outputting 3V voltage can be freely designed depending on different required output voltages.

It should be noted that, in this embodiment, the commercial power received by one of the first AC power input end 14 and the second AC power input end 16 is the master power supply, and the commercial power received by the other is the slave power supply. For example, if the commercial power received by the first AC power input end 14 is the master power supply, when the first AC power input end 14 works abnormally or the commercial power received by the first AC power input end 14 is unavailable, the slave power supply (which is the second AC power input end 16) will provide the power required by the dual input voltage power supply 10. The capacitor 37 and the inductor 38 on the circuit board 20 are part of the power factor correction circuit 24, and they are connected through the wiring embedded in the circuit board 20. Moreover, a fan 39 is configured on the circuit board 20 to dissipate the heat generated during the operation of the dual input voltage power supply 10.

To sum up, the dual input voltage power supply provided by the present disclosure has a first AC power input end and a second AC power input end, so a first commercial power can be received by the first AC power input end and a second commercial power can be received by the second AC power input end. Thus, when one of the first commercial power and the second commercial power is unavailable, the other can be a substitute. The dual input voltage power supply provided by the present disclosure can be used in DC power supply devices, such as an uninterruptable power system. In addition, the dual input voltage power supply provided by the present disclosure can also be used in a solar power generation device or, a wind power generation device, which helps to save energy and reduce carbon emission.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A dual input voltage power supply, comprising:
a first AC power input end, receiving a first commercial power;
a second AC power input end, receiving a second commercial power;
an AC selector relay, connected to the first AC power input end and the second AC power input end for choosing to receive the first commercial power from the first AC power input end or the second commercial power from the second AC power input end;
a power factor correction circuit, connected to the AC selector relay for power factor correction;
a support circuit, connected to the power factor correction circuit to provide a support power;
a DC/DC converter, connected to the power factor correction circuit; and
a voltage adjusting module, connected to the DC/DC converter, having a plurality of DC power output ends;
wherein one of the first AC power input end and the second AC power input end is a master power supply and the other is a slave power supply.

2. The dual input voltage power supply according to claim 1,
wherein the voltage adjusting module includes a first voltage adjusting module, a second voltage adjusting module and a plurality of third voltage adjusting modules;
wherein the first voltage adjusting module is a 12V voltage adjusting module, the second voltage adjusting module is a 5V voltage adjusting module and the third voltage adjusting module is a 3V voltage adjusting module.

3. The dual input voltage power supply according to claim 1, further comprising a controller of the AC selector relay, wherein two input ends of the controller of the AC selector relay are connected respectively to the first AC power input end and the second AC power input end, and an output end of the controller of the AC selector relay is connected to the AC selector relay.

4. The dual input voltage power supply according to claim 1, wherein the voltage adjusting module has a plurality of output power lines to provide a plurality of DC power outputs.

5. The dual input voltage power supply according to claim 1, wherein when the master power supply works abnormally, the slave power supply provides the power required by the dual input voltage power supply.

6. A dual input voltage power supply, comprising:
a housing;
a first AC power input end, configured at a front end of the housing to receive a first commercial power;
a second AC power input end, configured at the front end of the housing and beside the first AC power input end to receive a second commercial power; and
a circuit board, configured in the housing and connected to the first AC power input end and the second AC power input end, wherein the circuit board includes:
an AC selector relay, connected to the first AC power input end and the second AC power input end for choosing to receive the first commercial power from the first AC power input end or the second commercial power from the second AC power input end;
a power factor correction circuit, connected to the AC selector relay for power factor correction;
a support circuit, connected to the power factor correction circuit to provide a support power;
a DC/DC converter, connected to the power factor correction circuit; and
a voltage adjusting module, connected to the DC/DC converter, having a plurality of DC power output ends;
wherein one of the first AC power input end and the second AC power input end is a master power supply and the other is a slave power supply.

7. The dual input voltage power supply according to claim 6,
wherein the voltage adjusting module includes a first voltage adjusting module, a second voltage adjusting module and a plurality of third voltage adjusting modules;
wherein the first voltage adjusting module is a 12V voltage adjusting module, the second voltage adjusting module is a 5V voltage adjusting module and the third voltage adjusting module is a 3V voltage adjusting module.

8. The dual input voltage power supply according to claim 6, further comprising a controller of the AC selector relay, wherein two input ends of the controller of the AC selector relay are connected respectively to the first AC power input end and the second AC power input end, and an output end of the controller of the AC selector relay is connected to the AC selector relay.

9. The dual input voltage power supply according to claim 6, wherein the voltage adjusting module has a plurality of output power lines to provide a plurality of DC power outputs.

10. The dual input voltage power supply according to claim 6, wherein when the master power supply works abnormally, the slave power supply provides the power required by the dual input voltage power supply.
